(19) United States
(12) Patent Application Publication
(10) Pub. No.: US 2016/0133195 A1
(43) Pub. Date: May 12, 2016

(54) ORGANIC LIGHT EMITTING DISPLAY DEVICE

(71) Applicant: SAMSUNG DISPLAY CO., LTD., Yongin-City (KR)

(72) Inventors: Kyong-Tae PARK, Yongin-City (KR); Dong-Yoon SO, Yongin-City (KR); Sung-Ho CHO, Yongin-City (KR); Yu-Hyun CHO, Yongin-City (KR)

(21) Appl. No.: 14/802,030

(22) Filed: Jul. 17, 2015

(30) Foreign Application Priority Data
Nov. 10, 2014 (KR) 10-2014-0155399

(51) Int. Cl. G09G 3/32; G09G 3/20

(52) U.S. Cl. CPC G09G 3/3283; G09G 3/2007; G09G 2300/0404; G09G 2330/08; G09G 2330/10; G09G 2310/027; G09G 2310/0272; G09G 2310/08; G09G 2330/028; G09G 2320/0626

(57) ABSTRACT

A data driver supplies data voltages to data lines based on gray values corresponding to display pixels, and supplies a compensation data voltage to an auxiliary data line based on a gray value of a repaired pixel. The data driver computes a coupling voltage between the auxiliary line and the display pixels according to the gray values corresponding to the display pixels, and determines the compensation data voltage according to the coupling voltage.

### CROSS-REFERENCE TO RELATED APPLICATION

Korean Patent Application No. 10-2014-0155399, filed on Nov. 10, 2014, and entitled, “Organic Light Emitting Display Device,” is incorporated by reference herein in its entirety.

### BACKGROUND

1. Field

One or more embodiments herein relate to an organic light emitting display device.

2. Description of the Related Art

A variety of displays have been developed. Examples include liquid crystal displays, plasma display panels, and organic light emitting displays. An organic light emitting display includes a display panel, data driver, a scan driver, and a power supply. The display panel includes pixels arranged at intersections of data lines and scan lines. The data driver supplies data voltages to the data lines. The scan driver supplies scan signals to the scan lines. The power supply supplies power voltages to the pixels. Each pixel emits light based on current supplied to an organic light emitting diode. The amount of current is based on a data voltage supplied through a corresponding data line.

### SUMMARY

In accordance with one or more embodiments, an organic light emitting display device includes a display area including display pixels connected to data lines; a non-display area including an auxiliary pixel connected to an auxiliary data line; an auxiliary line extending in a direction intersecting the data lines and the auxiliary data line, the auxiliary line to connect a repaired pixel and the auxiliary pixel; and a data driver to supply data voltages to the data lines according to gray values corresponding to the display pixels, and to supply a compensation data voltage to the auxiliary data line according to a gray value of the repaired pixel, wherein the data driver is to compute a coupling voltage between the auxiliary line and the display pixels according to the gray values corresponding to the display pixels and is to determine the compensation data voltage according to the coupling voltage.

The data driver may include a compensation voltage computer to compute a difference between a predetermined maximum coupling voltage and the coupling voltage as a compensation voltage; and a compensation current computer to compute a compensation current based on the compensation voltage.

The data driver may include an auxiliary current computer to convert the gray value of the repaired pixel into an auxiliary current. The data driver may include a compensation gray value computer to aggregate the compensation current and the auxiliary current and to convert the aggregated current to a compensation gray value, the compensation data voltage to be determined according to the compensation gray value.

The data driver may include a compensation offset computer to generate a compensation offset based on the compensation current; and a basic offset computer to generate a basic offset according to the gray value of the repaired pixel, the compensation data voltage to be determined according to the compensation offset and the basic offset.

The data driver may include a computer to aggregate the compensation offset, basic offset, and gray value of the repaired pixel and to output a compensation gray value, the compensation data voltage to be determined according to the compensation gray value. The data driver may include a gray value computer to compute red gray values supplied to red pixels, green gray values supplied to green pixels, and blue gray values supplied to blue pixels.

The data driver may include a coupling voltage computer to calculate red coupling voltages between the red pixels and the auxiliary line according to the red gray values, green coupling voltages between the green pixels and the auxiliary line according to the green gray values, and blue coupling voltages between the blue pixels and the auxiliary line according to the blue gray values, the coupling voltage computer to aggregate the red coupling voltages, green coupling voltages, and blue coupling voltages to generate the coupling voltage.

The coupling voltage computer may compute a first anode voltages for organic light emitting diodes in the red pixels according to the red gray values, second anode voltages for organic light emitting diodes in the green pixels according to the green gray values, and third anode voltages for organic light emitting diodes in the blue pixels according to the blue gray values.

The coupling voltage computer may calculate the red coupling voltages according to the first anode voltages for the organic light emitting diodes in the red pixels, the green coupling voltages according to the second anode voltages for the organic light emitting diodes in the green pixels, and the blue coupling voltages according to the third anode voltages for the organic light emitting diodes in the blue pixels.

The coupling voltage computer may include first look-up table representing a relationship between the red gray values and the red coupling voltages, a second look-up table representing a relationship between the green gray values and the green coupling voltages, and a third look-up table representing a relationship between the blue gray values and the blue coupling voltages, and the coupling voltage computer is to calculate the red coupling voltages based on the first look-up table, the green coupling voltages based on the second look-up table, and the blue coupling voltages based on the third look-up table.

The coupling voltage computer may include a look-up table representing a relationship between a gray value and a normalized coupling voltage, and the coupling voltage computer is to calculate the red coupling voltages, green coupling voltages, and blue coupling voltages using in common the look-up table. The display pixels may be connected to a same scan line.

The organic light emitting display device may include an scan line and emission control line intersecting the data lines and the auxiliary data line; and an scan driver to supply an scan signal to the scan line and an emission control signal to the emission control line. The display pixels and the auxiliary pixel may be connected to the scan line and the emission control line. The data driver may synchronize the data voltages and the compensation data voltage to each other, and may supply the synchronized data voltages and the compensation data voltage to the data lines and the auxiliary data lines.

In accordance with one or more other embodiments, a data driver circuit includes an interface; and a data driver coupled to the interface, wherein the data driver is to supply data voltages to data lines based on gray values corresponding to display pixels, and is to supply a compensation data voltage to an auxiliary data line based on a gray value of a repaired pixel, and wherein the data driver is to compute a coupling voltage between the auxiliary line and the display pixels according to the gray values corresponding to the display pixels and is to determine the compensation data voltage according to the coupling voltage.

The data driver may include a compensation voltage computer to compute a difference between a predetermined maximum coupling voltage and the coupling voltage as a compensation voltage; and a compensation current computer to compute a compensation current based on the compensation voltage.

The data driver may include an auxiliary current computer to convert the gray value of the repaired pixel into an auxiliary current. The data driver may include a compensation gray value computer to aggregate the compensation current and the auxiliary current and to convert the aggregated current to a compensation gray value, the compensation data voltage to be determined according to the compensation gray value.

### BRIEF DESCRIPTION OF THE DRAWINGS

Features will become apparent to those of skill in the art by describing in detail exemplary embodiments with reference to the attached drawings in which:

FIG. 1 illustrates an embodiment of an organic light emitting display device;

FIG. 2 illustrates an embodiment of pixels, auxiliary pixels, auxiliary lines, auxiliary data lines, and a second data driver;

FIG. 3 illustrates examples of data voltages output from a first data driver and compensation data voltages output from a second data driver;

FIG. 4 illustrates an embodiment of a method for driving an auxiliary current computing block;

FIG. 5 illustrates an example of a relationship between a gray value and current;

FIG. 6 illustrates an embodiment of a method for driving a compensation current computing block;

FIG. 7 illustrates an example of voltages applied to an anode electrode of an organic light emitting diode based on red gray, green gray, and blue gray values;

FIG. 8 illustrates an examples of coupling voltages;

FIG. 9 illustrates a threshold voltage of an organic light emitting diode;

FIG. 10 illustrates an embodiment of a method for driving a compensation data driving block;

FIG. 11 illustrates an example of a relationship between current and a gray value;

FIG. 12 illustrates an embodiment of display pixels and auxiliary pixels;

FIG. 13 illustrates an example of a relationship between a gray value and offset of a repaired pixel when display pixels emit light of a single color;

FIG. 14 illustrates a modified embodiment of a data driver;

FIG. 15 illustrates an example of a relationship between a gray value and a basic offset of auxiliary data;

FIG. 16 illustrates an example of a relationship between a compensation current and a compensation offset; and

FIG. 17 illustrates additional examples of coupling voltages.

### DETAILED DESCRIPTIONS

Example embodiments are described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art. In the drawings, the dimensions of layers and regions may be exaggerated for clarity of illustration. Like reference numerals refer to like elements throughout.

It is also noted that in this specification, “connected/coupled” refers to one component not only directly coupling another component but also indirectly coupling another component through an intermediate component. On the other hand, “directly connected/directly coupled” refers to one component directly coupling another component without an intermediate component.

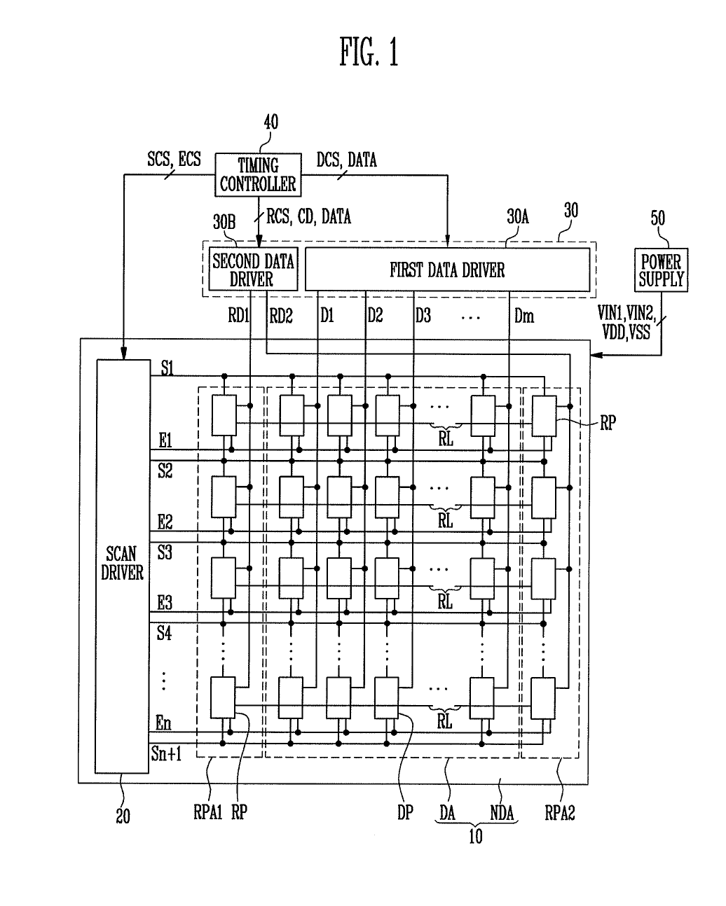

FIG. 1 illustrates an embodiment of an organic light emitting display device which includes a display panel 10, scan driver 20, data driver 30, timing controller 40, and power source 50.

The display panel 10 includes data lines D1 to Dm (m being a positive integer that is or above 2) and auxiliary data lines RD1 and RD2 that extend in a row direction, and scan lines S1 to Sn+1 and emission control lines E1 to En that extend in a line direction. The data lines D1 to Dm and auxiliary data lines RD1 and RD2 may be parallel to each other.

The auxiliary data lines RD1 and RD2 may be outside each side of the data lines D1 to Dm. For example, as illustrated in FIG. 1, the first auxiliary data line RD1 may be outside a left side of the data lines D1 to Dm. The second auxiliary data line RD2 may be outside a right side of the data lines D1 to Dm.

The data lines D1 to Dm and scan lines S1 to Sn+1 may intersect each other. The auxiliary data lines RD1 and RD2 and scan lines S1 to Sn+1 may intersect each other. The scan lines S1 to Sn+1 and emission control lines E1 to En may be parallel to each other.

The display panel 10 includes a display area DA (including display pixels DPs) and a non-display area NDA. The non-display area NDA may include a first auxiliary pixel area and a second auxiliary pixel area RPA1 and RPA2 that include auxiliary pixels RPs. The first auxiliary pixel area RPA1 includes auxiliary pixels RPs connected to the first auxiliary data line RD1. The second auxiliary pixel area RPA2 includes auxiliary pixels RPs connected to the second auxiliary pixel area RPA2.

The display area DA includes display pixels DPs arranged at intersecting areas of the data lines D1 to Dm and scan lines S1 to Sn+1 in a matrix format. In one embodiment, each display pixel DP may be connected to one data line, two scan lines, and one emission control line. Each display pixel DP emits light based on driving current supplied to an organic light emitting diode. The driving current is based on a data voltage from a data line. The display pixels DPs may include a red pixel, green pixel. and blue pixel, or a different combination of color pixels. In one embodiment, the display pixels DPs may include white pixels.

The first auxiliary pixel area RPA1 includes auxiliary pixels RPs arranged at intersecting areas of the first auxiliary data line RD1 and scan lines S1 to Sn+1. The second auxiliary pixel area RPA2 includes auxiliary pixels RPs arranged in intersecting areas of the second auxiliary data line RD2 and scan lines S1 to Sn+1.

The auxiliary pixels RPs are provided for repairing display pixels DPs that are defective. In one embodiment, each auxiliary pixel RP may be connected to one auxiliary data line, two scan lines, one emission control line, and one auxiliary line RL. The auxiliary lines RLs are connected to auxiliary pixels RPs, and extend from the auxiliary pixels RPs and traverse display pixel DPs of a corresponding line.

When a display pixel is defective, the display pixel is connected to an auxiliary line RL, for example, through a laser short-circuit process. Thus, the auxiliary pixel RP may be connected to the defective display pixel DP through the auxiliary line RL, and the defective display pixel DP may be repaired using the auxiliary pixel RP. Each auxiliary pixel RP may supply a driving current to a corresponding organic light emitting diode of a defective display pixel DP based on an auxiliary data voltage from a corresponding auxiliary data line. As a result, the defective display pixel DP may be repaired and emit light. A pixel where a defect had occurred and thus had been repaired may be referred to as a repaired pixel. In one embodiment, the display panel 10 includes a plurality of power voltage lines for supplying power voltages to the display pixels DPs and auxiliary pixels RP.

The scan driver 20 may include an scan signal output unit to output scan signals to the scan lines S1 to Sn+1 and a emission control signal output unit to output emission control signals to the emission control signal s E1 to En. The scan signal output unit receives an scan timing control signal SCS from the timing controller 40, and outputs scan signals to the scan lines S1 to Sn+1. The emission control signal output unit receives a light emission timing control signal ECS from the timing controller 40, and outputs light emitting control signals to the emission control lines E1 to En according to the light emission timing control signal ECS.

The scan signal output unit and emission control signal output unit may be directly formed in the non-display area (NDA) of the display panel 10 as in an amorphous silicon gate (ASG) method or a gate driver in panel (GIP) method. Each of the scan signal output unit and emission control signal output unit may include scan stages that are dependently connected. The scan stages may successively output the scan signals to the scan lines S1 to Sn+1. The light emission stages may successively output the emission control signals to the emission control signals E1 to En.

The data driver 30 includes a first data driver and a second data driver 30A and 30B. The first data driver 30A receives digital video data DATA and a source timing control signal DCS from the timing controller 40. The first data driver 30A converts the digital video data DATA into data voltages based on the source timing control signal DCS. In synchronism with each scan signal, the first data driver 30A supplies the data voltages to the data lines D1 to Dm. Accordingly, the data voltages may be supplied to the display pixels DP to which the scan signals are supplied through respective scan lines S1 to Sn+1. In an embodiment, the first data driver 30A may include a source drive IC.

The second data driver 30B receives a repair control signal RCS, digital video data DATA, and coordinate data CD of a repaired pixel. The second data driver 30B generates compensation data voltages using the repair control signal RCS, digital video data DATA, and coordinate data CD of the repaired pixel. The second data driver 30B supplies the compensation data voltages to the auxiliary data lines RD1 and RD2.

The timing controller 40 receives the digital video data DATA and timing signals, for example, from an external source. The timing controller 40 generates timing control signals for controlling the scan driver 30 and first data driver 30A based on the timing signals. The timing control signals include an scan timing control signal SCS for controlling a timing of operation of the scan signal output unit, light emission timing control signal ECS for controlling a timing of operation of the emission control signal output unit, and a data timing control signal DCS for controlling a timing of operation of the first data driver 30A. The timing controller 40 outputs the scan timing control signal SCS and light emission timing control signal ECS to the scan driver 20, and outputs the data timing control signal DCS and digital video data DATA to the first data driver 30.

The timing controller 40 generates a repair control signal RCS and coordinate data CD of a repaired pixel. The repair control signal RCS indicates whether or not there is a repaired pixel. For example, when there is a repaired pixel, the repair control signal RCS may be generated as a first logic level voltage. When there is no repaired pixel, the repair control signal RCS may be generated as a second logic level voltage. The coordinate data CD of a repaired pixel indicates a coordinate value of the repaired pixel. The coordinate data CD of the repaired pixel may be stored, for example, in an internal memory of the timing controller 40. The timing controller 40 outputs the repair control signal RCS, coordinate data CD of the repaired pixel, and digital video data DATA to the second data driver 30B.

The power source 50 may supply power voltages to the power source voltage lines. As illustrated in FIG. 1, the power source 50 may supply first to fourth power voltages VIN1, VIN2, VDD, and VSS to first to fourth power voltage lines. The power source 50 may also supply a gate-off voltage and a gate-on voltage to the scan driver 20.

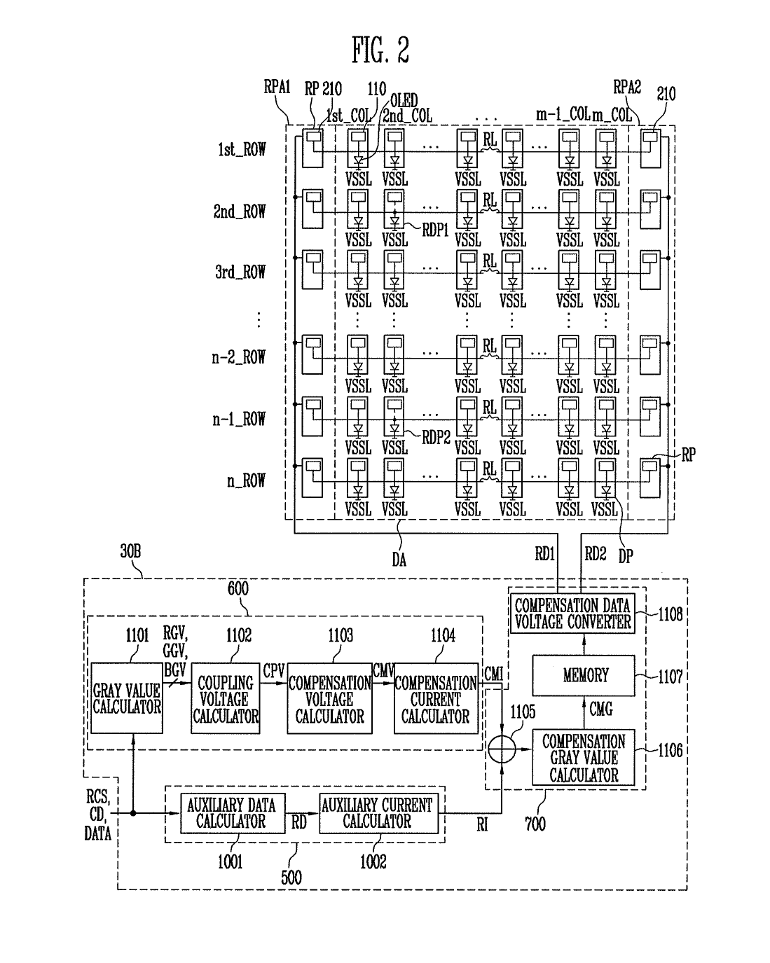

FIG. 2 illustrates an embodiment which includes display pixels, auxiliary pixels, auxiliary lines, auxiliary data lines, and a second data driver. The display pixels DP, auxiliary pixels RP, auxiliary lines RL, auxiliary data lines RD1 and RD2, and a second data driver 30B may correspond to those in display panel 10.

Referring to FIG. 2, each display pixel DP includes a display pixel driver 110 and organic light emitting diode OLED. The organic light emitting diode OLED emits light with a brightness corresponding to a driving current from the display pixel driver 110. The anode electrode of the organic light emitting diode OLED may be connected to the display pixel driver 110, and the cathode electrode may be connected to a fourth power voltage line VSSL to which a fourth power voltage is supplied. The fourth power voltage may be a predetermined (e.g., low potential) power voltage.

Each auxiliary pixel RP includes an auxiliary pixel driver 210 connected to an auxiliary line RL. The auxiliary pixel driver 210 supplies driving current to the auxiliary line RL according to an auxiliary data voltage from the auxiliary data line RD1 or RD2.

The auxiliary line RL is connected to the auxiliary pixel RP and extends from the auxiliary pixel RP to the display area DA and traverses the display pixels DP of a same line. For example, as illustrated in FIG. 2, the auxiliary line RL is connected to the auxiliary pixel RP of a p^{th} line (1≦p≦n, p being a positive integer) and traverses the display pixels DP of the p^{th} line. Also, as illustrated in FIG. 2, the auxiliary line RL may traverse the anode electrodes of the organic light emitting diodes OLEDs of the display pixels DP.

The auxiliary line RL may be connected to one of the display pixels DP of the display area DA. The display pixel DP connected to the auxiliary line RL is a defective pixel that must be repaired. In FIG. 2, the display pixel DP connected to the auxiliary line RL is defined as a repaired pixel RDP1 and RDP2. For example, the auxiliary line RL may be connected to the anode electrode of the organic light emitting diode OLED of the repaired pixel RDP1 and RDP2. The display pixel driver 110 and the organic light emitting diode OLED of the repaired pixel RDP1 and RDP2 are disconnected from each other.

The auxiliary pixels RP of the first auxiliary pixel area RPA1 are connected to the first auxiliary data line RD1. The auxiliary pixels RP of the second auxiliary pixel area RPA2 are connected to the second auxiliary data line RD2. The display pixels DP of the display area DA are connected to the data lines D1 to Dm.

The second data driver 30B includes an auxiliary current computing block 500, compensation current computing block 600, and compensation data driving block 700. The auxiliary current computing block 500 includes an auxiliary data calculator 1001 and an auxiliary current calculator 1002. The compensation current computing block 600 includes a gray value calculator 1101, coupling voltage calculator 1102, compensation voltage calculator 1103, and compensation current calculator 1104. The compensation data driving block 700 includes an calculator 1105, compensation gray value calculator 1106, memory 1107, and compensation data voltage converter 1108.

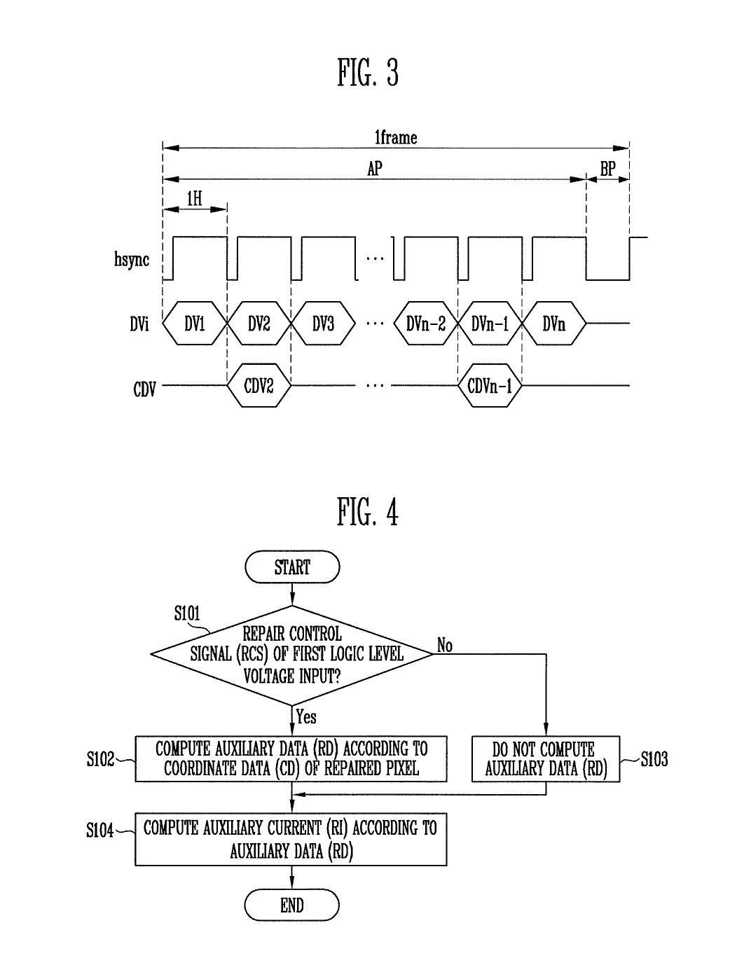

FIG. 3 is a timing diagram for illustrating examples of data voltages output from the first data driver and compensation data voltages output from the second data driver of FIG. 2. FIG. 3 illustrates a horizontal sync signal hsync, data voltages DVi output to an i^{th} data line Di (1≦i≦m, i being a positive integer), and compensation data voltages CDV output to the first or second auxiliary data line RD1 and RD2.

Referring to FIG. 3, a first frame period 1frame includes an active period AP where data voltages are supplied to the display pixels, and a blank period BP which is a break period. The horizontal sync signal hsync is provided as a pulse in 1 horizontal period 1H cycle. The data voltages DVi output to the i^{th} data line Di may include a first to n^{th} data voltages DV1 to DVn.

A compensation data voltage, supplied to an auxiliary pixel RP connected to a repaired pixel of a p^{th} line through an auxiliary line RL, is synchronized with a data voltage supplied to the repaired pixel of the p^{th} line. That is because the repaired pixel of the p^{th} line and the auxiliary pixel RP, connected thereto through the auxiliary line RL, receive a data voltage and compensation data voltage by a same scan signal.

As illustrated in FIG. 2, when a first repaired pixel RDP1 is positioned in a second line, a second compensation data voltage (CDV2) supplied to an auxiliary pixel RP connected to the first repaired pixel RDP1 may be supplied in synchronization with a second data voltage DV2 supplied to the first repaired pixel RDP1. When a second repaired pixel RDP2 is positioned in an n−1^{th} line, an n−1^{th} compensation data voltage (CDVn−1), supplied to an auxiliary pixel RP connected to the second repaired pixel RDP2, may be supplied in synchronization with an n−1^{th} data voltage (DVn−1) supplied to the second repaired pixel RDP2.

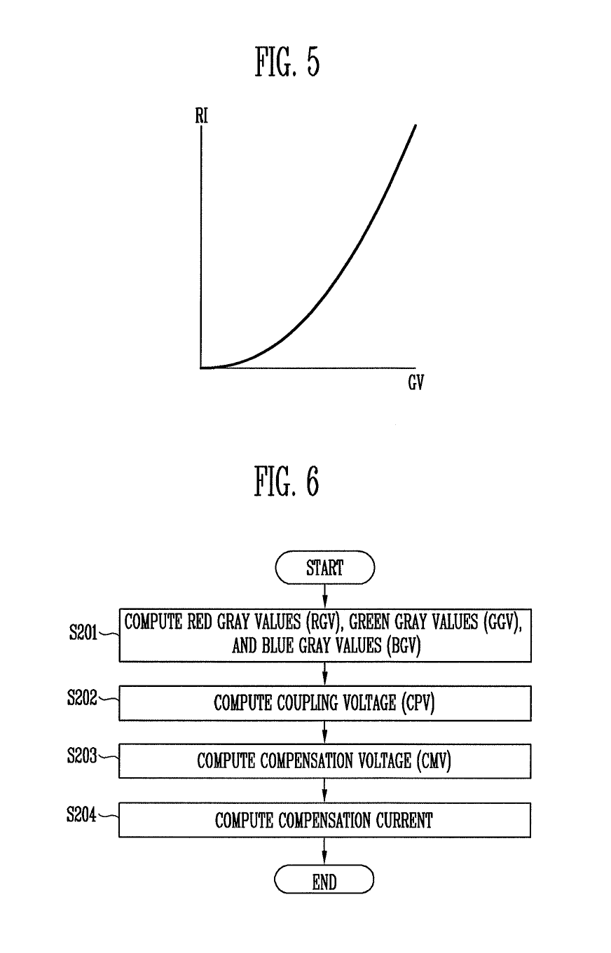

FIG. 4 illustrates an embodiment of a method for driving an auxiliary current computing block of FIG. 2. FIG. 5 is a graph illustrating an example of a relationship between a gray value and current.

Referring to FIGS. 2 and 4, the auxiliary data calculator 1001 receives a repair control signal RCS, digital video data DATA, and coordinate data CD of the repaired pixel RDP1 and RDP2 from the timing controller 40.

In operation S101, the auxiliary data calculator 1001 determines whether or not a repair control signal RCS of a first logic level voltage is input. In operation S102, when a repair control signal RCS of a first logic level voltage is input, the auxiliary data calculator 1001 computes auxiliary data RD. In operation S103, when a repair control signal RCS of a second logic level voltage is input, the auxiliary data calculator 1001 does not compute auxiliary data RD. For example, the auxiliary data calculator 1001 computes the auxiliary data RD from the digital video data DATA according to the coordinate data CD of the repaired pixel based on the repair control signal RCS of a first logic level voltage.

In one embodiment, the auxiliary data calculator 1001 computes as auxiliary data RD digital video data corresponding to the coordinate value of the repaired pixel RDP1 and RDP2 of the digital video data DATA. For example, when the first repaired pixel RDP1 is positioned in a second row line 2nd_ROW and a second column line 2nd_COL as illustrated in FIG. 2, the coordinate value of the first repaired pixel RDP1 may be (2,2).

In FIG. 2, row lines and column lines of the display area DA are displayed. When the second repaired pixel RDP2 is positioned in an n−1 th row line n−1_ROW and second column line 2nd_COL, the coordinate value of the second repaired pixel RDP2 may be (n−1,2). The auxiliary data calculator 1001 computes digital video data corresponding to coordinate value (2,2) as auxiliary data RD to be supplied to the auxiliary pixel RP of the first repaired pixel RDP1. The auxiliary data calculator 1001 will compute digital video data corresponding to coordinate value (n−1,2) as auxiliary data RD to be supplied to the auxiliary pixel RP of the second repaired pixel RDP2.

In operation S104, the auxiliary current calculator 1004 generates a current RI according to the auxiliary data RD. Referring to FIG. 5, the x axis represents a gray value GV corresponding to the auxiliary data RD, and the y axis represents an auxiliary current RI. As the gray value GV increases, the auxiliary current RI increases. The auxiliary current calculator 1104 receives the auxiliary data RD and converts the auxiliary data RD to the auxiliary current RI, for example, according to the graph in FIG. 5. For example, a look-up table representing a relationship between a gray value GV and auxiliary current RI is provided based on the graph of FIG. 5. The auxiliary current calculator 1104 may calculate the auxiliary current RI according to such a look-up table. The generated auxiliary current RI is provided to the calculator 1105.

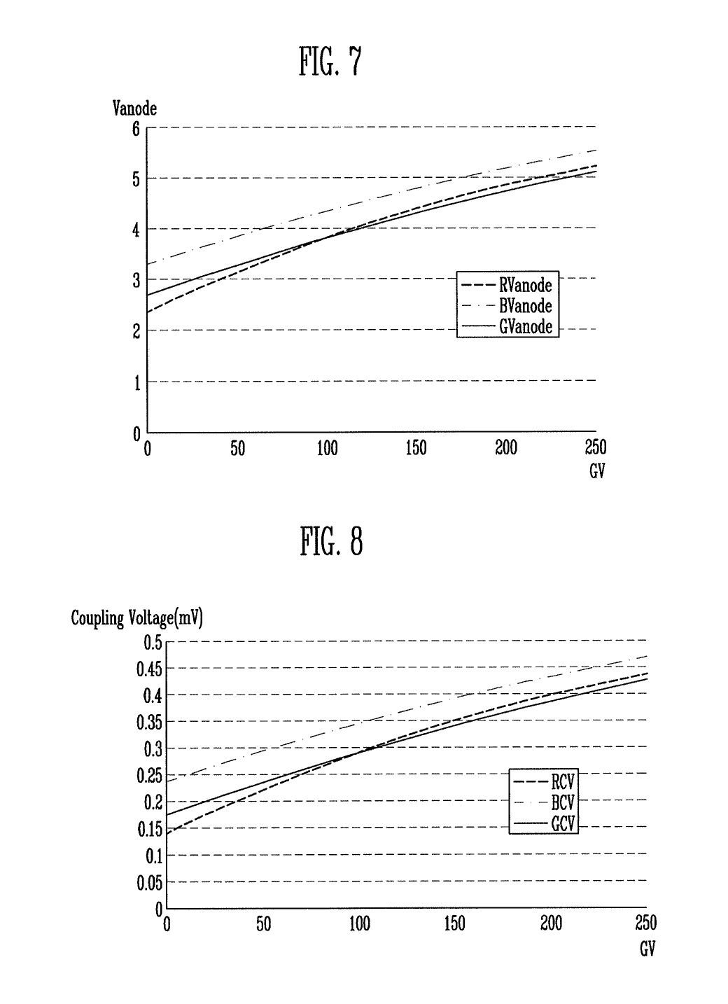

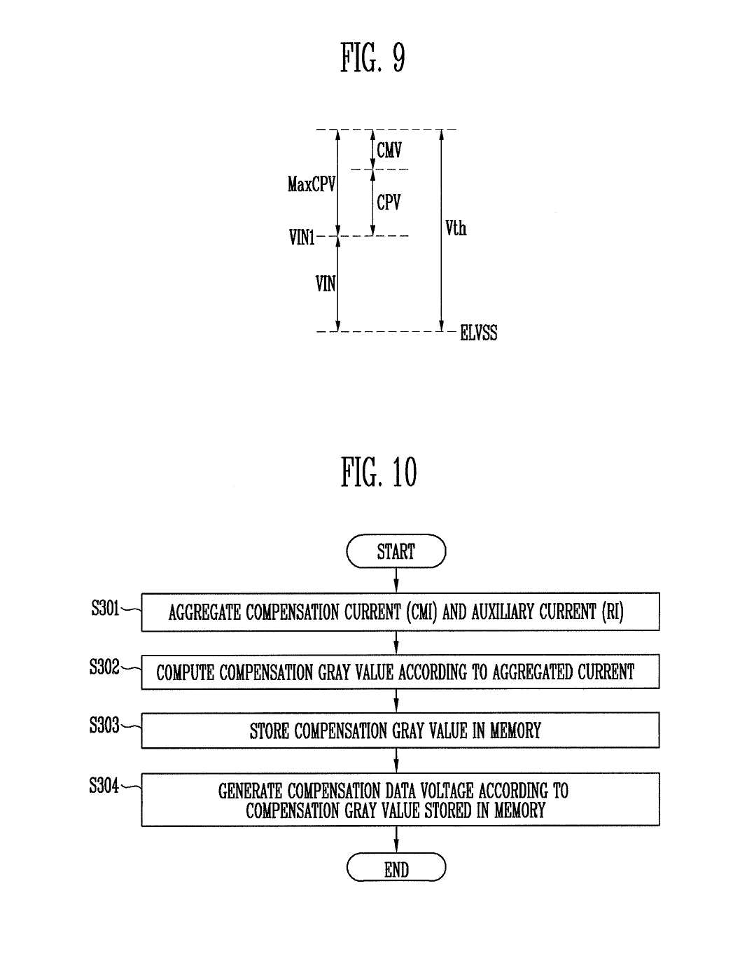

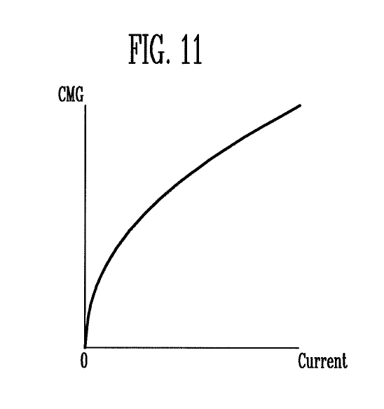

FIG. 6 illustrates an embodiment of a method for driving a compensation current computing block of FIG. 2. FIG. 7 is a graph illustrating examples of voltages applied to an anode electrode of an organic light emitting diode according to a red gray value, green gray value, and blue gray value. FIG. 8 is a graph illustrating examples of a coupling voltage according to a red gray value, a coupling voltage according to a green gray value, and a coupling voltage according to a blue gray value. FIG. 9 illustrates an example of a threshold voltage of an organic light emitting diode.

Referring to FIGS. 2 and 6, in operation S201, the gray value calculator 1101 computes red gray values RGV supplied to the red pixels, green gray values GGV supplied to the green pixels, and blue gray values BGV supplied to the blue pixels connected to a same scan line as the repaired pixels RDP1 and RDP2.

The gray value calculator 1101 receives the digital video data DATA and the coordinate data CD of the repaired pixels RDP1 and RDP2, for example, from the timing controller 40. When the digital video data DATA is digital data of 8 bit per pixel, 0 to 255 gray values are possible.

Then, the gray value calculator 1101 computes the red gray values RGV supplied to the red pixels, the green gray values GGV supplied to the green pixels, and the blue gray values BGV supplied to the blue pixels connected to the same scan line as the repaired pixels RDP1 and RDP2. For example, consider the case where the coordinate value of the first repaired pixel RDP1 is (2,2). For display pixels DP having coordinate values (2,1) to (2,m), red gray values RGV supplied to the red pixels, green gray values GGV supplied to the green pixels, and blue gray values BGV supplied to the blue pixels are computed. The coordinate value of the second repaired pixel RDP2 is (n−1,2). For display pixels having coordinate values (n−1,1) to (n−1,m), the red gray values RGV supplied to the red pixels, the green gray values GGV supplied to the green pixels, and the blue gray values (BGVs) supplied to the blue pixels are computed.

The gray value calculator 1101 outputs the red gray values RGV, green gray values GGV, and blue gray values BGV to the coupling voltage calculator 1102.

In operation S202, the coupling voltage calculator 1102 computes a coupling voltage CPV using the red gray values RGV, green gray values GGV, and blue gray values BGV. The coupling voltage CPV means a voltage where the auxiliary line RL is affected by the red pixels, green pixels, and blue pixels connected to a same scan line as the repaired pixels RDP1 and RDP2.

For example, the coupling voltage calculator 1102 computes: a red anode voltage RVanode supplied to an anode electrode of a red organic light emitting diode according to each red gray value RGV; a green anode voltage GVanode supplied to an anode electrode of a green organic light emitting diode according to each green gray value GGV: and a blue anode voltage BVanode supplied to an anode electrode of a blue organic light emitting diode according to each blue gray value BGV. These voltages be computed with reference to a relationship between a gray value and a voltage applied to an anode electrode as in FIG. 7.

In FIG. 7, the x axis represents a gray value GV of 8 bit digital video data and the y axis represents an anode voltage Vanode of an organic light emitting diode. The graph in FIG. 7 is computed through calculation after determining a current, voltage, and brightness of an organic light emitting diode of each of the red, green, and blue display pixels, a transmission ratio of a polarized panel attached to the display panel, an open ratio and maximum brightness of each of the display pixels, and a gamma value.

According to the graph in FIG. 7, a red look-up table representing a relationship between the red gray value RGV and red anode voltage RVanode, a green look-up table representing a relationship between the green gray value GGV and green anode voltage GVanode, and a blue look-up table representing a relationship between the blue gray value BGV and blue anode voltage BVanode may be implemented. The coupling voltage calculator 1102 may compute red anode voltages according to each red gray value RGV with reference to the red look-up table, green anode voltages according to each green gray value GGV with reference to the green look-up table, and blue anode voltages according to each blue gray value BGV with reference to the blue look-up table.

The coupling voltage calculator 1102 may compute a red coupling voltage RCV from the red anode voltage RVanode, for example, based on Equations 1 and 2.

ΔRV=RVanode−(VIN1−ELVSS) (1)

$$RCV = Δ RV \times \frac{Crp}{Cptotal} \qquad ( 2 )$$

In Equations 1 and 2, RVanode refers to a red anode voltage, VIN1 refers to an initial value of an anode electrode of an organic light emitting diode of a red pixel, ELVSS refers to a fourth power voltage, Crp refers to a parasitic capacitance between the anode electrode of the organic light emitting diode of the red pixel and the auxiliary line RL, and Cptotal refers to a parasitic capacitance of the auxiliary line RL. The initial value VIN1 of the anode electrode may be consider to be a first power voltage VIN1.

The coupling voltage calculator 1102 may compute a green coupling voltage GCV from the green anode voltage GVanode, for example, based on Equations 3 and 4.

$$\begin{matrix}Δ GV = GVanode - ( VIN 1 - ELVSS ) & ( 3 ) \\ GCV = Δ GV \times \frac{Cgp}{Cptotal} & ( 4 )\end{matrix}$$

In Equations 3 and 4, GVanode refers to a green anode voltage of a green pixel, VIN1 refers to a first power voltage of the green pixel, ELVSS refers to a fourth power voltage, Cgp refers to a parasitic capacitance between an anode electrode of an organic light emitting diode of the green pixel and the auxiliary line RL, and Cptotal refers to a parasitic capacitance of the auxiliary line RL.

The coupling voltage calculator 1102 may compute a blue coupling voltage BCV from the blue anode voltage BVanode, for example, based on Equations 5 and 6.

ΔBU=BVanode−(VIN1−ELVSS) (5)

$$BCV = Δ BV \times \frac{Cbp}{Cptotal} \qquad ( 6 )$$

In Equations 5 and 6, BVanode refers to a blue anode voltage of a blue pixel, VIN1 refers to a first power voltage of the blue pixel, ELVSS refers to a fourth power voltage, Cbp refers to a parasitic capacitance between an anode electrode of an organic light emitting diode of the blue pixel and the auxiliary line RL, and Cptotal refers to a parasitic capacitance of the auxiliary line RL.

The red coupling voltage RCV, green coupling voltage GCV, and blue coupling voltage BCV computed using Equations 1 to 6 may be proportional to an approximate gray value, for example, as in FIG. 8. In FIG. 8, the x axis represents a gray value GV of 8 bit digital video data and the y axis represents a coupling voltage.

In one embodiment, a coupling voltage for each pixel connected to a same scan line as the repaired pixels RDP1 and RDP2 may be determined according to the curves in FIG. 8. In such a case, an arithmetic operation corresponding to Equations 1 to 6 may not be required. For example, a gray value of each corresponding pixel may be applied to a corresponding graph of FIG. 8, to thereby determine a coupling voltage. For example, a look-up table corresponding to each curve of FIG. 8 may be provided, and the coupling voltage calculator 1102 may compute a coupling voltage corresponding to each pixel according to such a look-up table.

The coupling voltage calculator 1102 may compute an sum of red coupling voltages RCV, an sum of green coupling voltages GCV, and an sum of blue coupling voltages BCV as a coupling voltage CPV, for example, as in Equation 7.

CPV=ΣRCV+ΣGCV+ΣBCV (7)

The coupling voltage calculator 1102 outputs the coupling voltage CPV to the compensation voltage calculator 1103. The compensation voltage calculator 1103 receives the coupling voltage CPV from the coupling voltage calculator 1102 and computes a difference between a maximum coupling voltage MaxCPV and the coupling voltage CPV as a compensation voltage CMV, for example, as in Equation 8.

CMV=MaXCPV−CPV (8)

Referring to FIG. 8, the first power voltage VIN1 is set to a voltage that corresponds to a sum of the fourth power voltage ELVSS and a predetermined voltage VIN. Under some circumstances, erroneous light emission from the organic light emitting diode connected to the auxiliary line RL may occur as a result of the coupling voltage CPV generated by parasitic capacitances between the auxiliary line RL and display pixels DP. In order to prevent this situation, the threshold voltage Vth of the organic light emitting diode connected to the auxiliary line RL may be set to a voltage that corresponds to a sum of the predetermined voltage VIN and the maximum coupling voltage MaxCPV. The maximum coupling voltage MaxCPV refers to a maximum value of the coupling voltage CPV.

The coupling voltage CPV varies depending on a gray that the display pixels DP display. For example, as the gray that the display pixels DP display increases, the coupling voltage CPV increases. As the gray that the display pixels DP display decreases, the coupling voltage CPV decreases (see, e.g., FIG. 8). On the other hand, a potential of the auxiliary line RL may be kept constant. In order to prevent the potential of the auxiliary line RL from changing according to the coupling voltage CPV, the compensation voltage CMV is computed based on a difference between the maximum coupling voltage MaxCPV and the coupling voltage. Consequently, regardless of the coupling voltage CPV, the potential of the auxiliary line RL may be set to be substantially equal to the threshold voltage Vth of the organic light emitting diode. As a result, the organic light emitting diode of the repaired pixel is prevented from erroneously emitting light. Therefore, an organic light emitting display device having an improved reliability may be provided.

The compensation voltage calculator 1103 outputs the compensation voltage CMV to the compensation current calculator 1104.

In operation S204, the compensation current calculator 1104 computes a compensation current CMI according to the compensation voltage CMV. For example, a compensation current CMI provided during the first frame period 1frame may be computed based on the compensation voltage CMV. In another example, a compensation current CMI, provided during a period where one line is selected, may be computed using the compensation voltage CMV.

In one embodiment, in the compensation current CMI, the capacitance of the auxiliary line RL and the capacitance of the repaired pixel may be taken into account as an impedance.

$$CPV = \frac{1}{Cptotal + Coled} {\int }_{0}^{t} CMI d t = \frac{t \times CMI}{Cptotal + Coled} \qquad ( 9 )$$

Referring to Equation 9, Cptotal represents the capacitance of the auxiliary line RL, Coled represents the capacitance of the repaired pixel, and t represents the period of time where the compensation current CMI is to be provided. The parameter t may correspond, for example, to the first frame period.

The compensation current CMI, provided during a period of time t, may be computed by an integral calculus. The compensation voltage CPV may be computed by dividing the compensation current CMI provided during a period of time t by an sum of the capacitance Cptotal of the auxiliary line RL and the capacitance Coled of the repaired pixel. For example, the compensation voltage CPV may be computed by dividing the product of the period of time t and the compensation current CMI by the sum of the capacitance Cptotal of the auxiliary line and the capacitance Coled of the repaired pixel. The compensation current CMI may be calculated based on Equation 9, as in Equation 10.

$$CPI = CPV \times \frac{Cptotal \times Coled}{t} \qquad ( 10 )$$

Referring to Equation 10, the compensation current CMI is calculated by multiplying the compensation voltage CPV by the sum of the capacitance Cptotal of the auxiliary line RL and the capacitance Coled of the repaired pixel, and then dividing the result by the period of time t.

In the present invention, a coupling voltage CPV, generated by the parasitic capacitances formed between the display pixels DP connected to the same scan line as the repaired pixels RDP1 and RDP2, is computed the compensation current CMI is computed based on the result.

FIG. 10 illustrates an embodiment of a method for driving a compensation data driving block, and FIG. 11 is a graph illustrating an example of a relationship between current and a gray value.

Referring to FIGS. 2 and 10, in operation S301, the calculator 1105 aggregates the compensation current CMI and the auxiliary current RI. For example, a factor corresponding to the coupling voltage CPV is computed as the compensation current CMI, a factor corresponding to the auxiliary data RD is computed as the auxiliary current RI, and a factor corresponding to the coupling voltage CPV and a factor corresponding to the auxiliary data RD may be aggregated. The aggregated current is output to the compensation gray value calculator 1106.

In operation S302, the compensation gray value calculator 1106 outputs a compensation gray value CMG according to the aggregated current. For example, a look-up table representing a relationship between the current and compensation gray value CMG may be provided. The compensation gray value calculator 1106 may output the compensation gray value CMG corresponding to the aggregated current based on such a look-up table.

In FIG. 11, the x axis represents an aggregated current amount and the y axis represents the compensation gray value CMG. As the aggregated current amount increases, the compensation gray value CMG increases. The compensation gray value calculator 1106 receives the aggregated current amount and calculates the compensation gray value CMG according to the graph in FIG. 11.

Referring again to FIG. 10, in operation S303, the compensation gray value CMG is stored in a memory 1107. In one embodiment, the memory 1107 may be set to be updated to initialized data, for example, at every predetermined period. For example, the memory 1107 may receive a signal indicating a predetermined period from the timing controller 40 (see FIG. 1). The signal indicating a predetermined period of time may be, for example, a vertical sync signal vsync where a pulse is generated at every first frame period, or a horizontal sync signal hsync where a pulse is generated at every first horizontal period. The first frame period may correspond to a period where data voltages are supplied to all the display pixels DP. The first horizontal period may correspond to a period where data voltages are supplied to display pixels DP of one line.

When the signal indicating a predetermined period of time is a vertical sync signal vsync, the memory 1107 may be updated to initialized data every first frame period. When the signal indicating a predetermined period of time is a horizontal sync signal hsync, the memory 1107 may be updated to initialized data every first horizontal period. The memory 1107 may be or include a register. The memory 1107 may output the data CMG stored therein to a compensation data voltage converter 1108 at every horizontal period.

In operation S304, the compensation data voltage converter 1108 converts the compensation gray value CMG stored in the memory 1107 to compensation data voltage. The converted compensation data voltage is supplied to a corresponding auxiliary line RL. When the memory 1107 is initialized and thus the compensation gray value CMG is changed to initialized data, the compensation data voltage converter 1108 may output a default voltage according to the initialized data. For example, when an scan signal is input into a second line, the compensation data voltage converter 1109 may deliver the compensation data voltage to the first repaired pixel RDP1 RDP1 through the auxiliary line RL. For example, when a scan signal is input to another line that does not include a repaired pixel, the compensation data voltage converter 1108 may output a default voltage to the auxiliary line RL.

In the present embodiment, the coupling voltage CPV is computed according to the gray values of the display pixels DP, and the compensation current CMI is computed according to the coupling voltage CPV. Such a compensation current CMI is aggregated with the auxiliary current RI corresponding to the auxiliary data RD. The compensation gray value CMG is calculated according to the aggregated current. The repaired pixels RDP1 and RDP2 are driven according to the compensation gray value CMG. Because a compensation gray value CMG is used which takes the coupling voltage CPV into account, the potential of the auxiliary line RL may be controlled effectively.

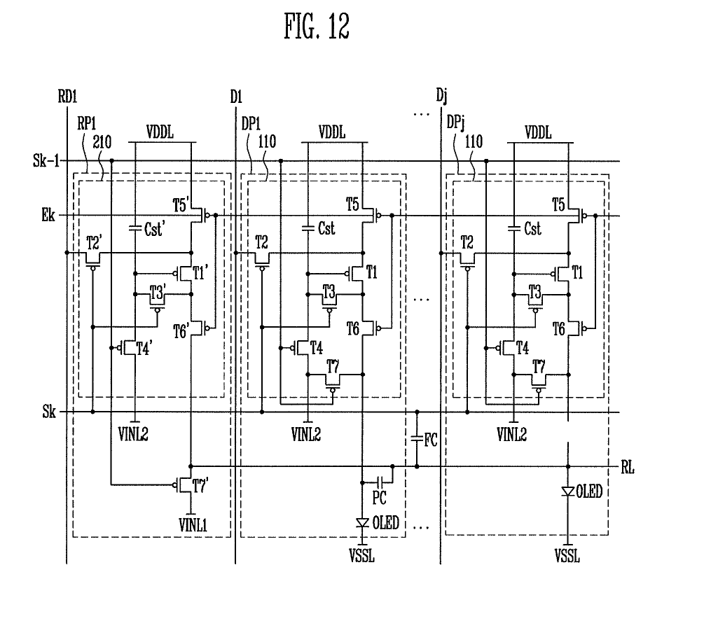

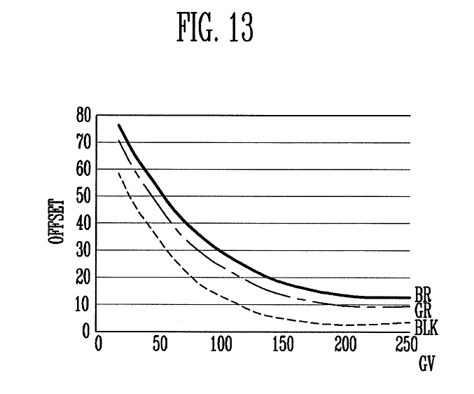

FIG. 12 illustrates an embodiment of display pixels and auxiliary pixels. In FIG. 12, k−1^{th} and k^{th} scan lines Sk−1, and Sk (k being a positive integer satisfying 2≦k≦n), a first auxiliary data line RD1, first and j^{th} data lines D1 and Dj (j being a positive integer satisfying 2≦j≦m), and k^{th} and k+α^{th} emission control lines Ek and Ek+α are illustrated as examples Furthermore, FIG. 12 illustrates the first auxiliary pixel RP1 connected to the first auxiliary data line RD1, first display pixel DP1 connected to the first data line DE and the j^{th} display pixel DPj connected to the j^{th} data line Dj. Also, in FIG. 12, the first display pixel DP1 is a pixel where a defect did not occur during a manufacturing process, and the j^{th} display pixel DPj is a pixel where a defect occurred during a manufacturing process and thus had been repaired. Hereinafter, the first auxiliary pixel RP1, first display pixel DP1, and j^{th} display pixel DPj will be explained in detail in relation to FIG. 12.

Referring to FIG. 12, the first auxiliary pixel RP1 is connected to the j^{th} display pixel DPj through the auxiliary line RL. The auxiliary line RL may be formed to extend to the display area DA from the first auxiliary pixel RP1 and traverse the display pixels DP1 and DPj). For example, the auxiliary line RL may be formed to traverse the anode electrodes of the organic light emitting diode OLED of the display pixels DP1 and DPj as in FIG. 12.

The auxiliary line RL may be connected to the organic light emitting diode OLED of the j^{th} display pixel DPj. In this case, the display pixel driver 110 and the organic light emitting diode OLED of the j^{th} display pixel DPj are disconnected from each other.

Each of the display pixels DP1 and DPj includes an organic light emitting diode OLED and display pixel driver 110. The display pixel driver 110 is connected to the organic light emitting diode OLED and supplies a driving current to the organic light emitting diode. However, the display pixel driver 110 and the organic light emitting diode OLED of the j^{th} display pixel DPj corresponding to the repaired pixel are disconnected from each other.

The display pixel driver 110 may be connected to a plurality of scan lines, a data line, emission control lines, and a plurality of power lines. The display pixel driver 110 may be connected to the k−1^{th} and k^{th} scan lines Sk−1 and Sk, data line D1 and Dj, k^{th} emission control line Ek, and second and third power voltage lines VDDL and VINL2 as in FIG. 12. A second power voltage is supplied to the second power voltage line VINL2, and a third power voltage is supplied to the third power voltage line VDDL. The second power voltage may an initialization power voltage for initializing the display pixel driver 110. The third power voltage may be a high potential power voltage.

In one embodiment, the second power voltage may be different from the first power voltage. For example, the first power voltage may be set to be substantially the same as the fourth power voltage, or may be a voltage that corresponds to an sum of the fourth power voltage and a predetermined voltage. The second power voltage may be set to be a predetermined direct current voltage, e.g. −3.5V in this example.

The display pixel driver 110 may include a plurality of transistors. For example, the display pixel driver 110 may include a first to a seventh transistor T1 T2, 13, T4, T5, T6, and T7 and storage capacitor Cst.

The first transistor T1 controls a driving current (drain-source current, Ids) according to the voltage of a control electrode. The driving current Ids flowing through a channel of the first transistor T1 is proportional to the square of the difference between a voltage between the control electrode and first electrode of the first transistor T1 and a threshold voltage, as shown in Equation 11.

I_{ds}=k′·(V_{gs}−Vₜₕ)² (11)

In Equation 11, k′ is a proportional coefficient determined based on a structure and/or physical characteristics of the first transistor T1, Vgs is a voltage between the control electrode and first electrode of the first transistor T1, and Vth is the threshold voltage of the first transistor T1.

The second transistor T2 is connected to the first electrode and data line D1/Dj of the first transistor T1. The second transistor (T2) is turned on by the scan signal of the k^{th} scan line Sk, and connects the first electrode and the data line D1 and Dj of the first transistor T1. As a result, the data voltage of the data line D1 and Dj is supplied to the first electrode of the first transistor T1. The control electrode of the second transistor T2 is connected to the k^{th} scan line Sk, the first electrode is connected to the data line D1 and Dj, and the second electrode is connected to the first electrode of the first transistor T1. The control electrode may be a gate electrode, the first electrode may be a source electrode or drain electrode, and the second electrode may be an electrode different from the first electrode. For example, when the first electrode is a source electrode, the second electrode may be a drain electrode.

The third transistor T3 is connected to the control electrode and second electrode of the first transistor T1. The third transistor T3 is turned on by the scan signal of the k^{th} scan Sk to connect the control electrode and second electrode of the first transistor T1. In this case, the first transistor T1 is driven as a diode. The control electrode of the third transistor T3 is connected to the k^{th} scan line Sk, the first electrode is connected to the second electrode of the first transistor T1. The second electrode is connected to the control electrode of the first transistor T1.

The fourth transistor T4 is connected to the control electrode of the first transistor T1 and the second power voltage line VINL2 where the second power voltage is supplied. The fourth transistor T4 is turned on by the scan signal of the k−1^{th} scan line Sk−1 to connect the control electrode and second power voltage line VINI2 of the first transistor T1. As a result, the control electrode of the first transistor T1 may be initialized to the second power voltage. The control electrode of the fourth transistor T4 is connected to the k−1^{th} scan line Sk−1, the first electrode is connected to the control electrode of the first transistor T1, and the second electrode is connected to the second power voltage line VINI2.

The fifth transistor T5 is connected to the third power voltage line VDDL and the first electrode of the first transistor T1. The fifth transistor T5 is turned on by a emission control signal of the k^{th} emission control line Ek to connects the third power voltage line VDDL and the first electrode of the first transistor T1. As a result, the third power voltage is supplied to the first electrode of the first transistor T1. The control electrode of the fifth transistor T5 is connected to the k^{th} emission control line Ek, the first electrode is connected to the third power voltage line VDDL, and the second electrode is connected to the first electrode of the first transistor T1.

The sixth transistor T6 is connected to the second electrode and organic light emitting diode OLED of the first transistor T1. The sixth transistor T6 is turned on by a emission control signal of the k^{th} emission control line Ek to connect the second electrode and organic light emitting diode OLED of the first transistor T1. The control electrode of the sixth transistor T6 is connected to the k^{th} emission control line Ek, the first electrode is connected to the second electrode of the first transistor T1, and the second electrode is connected to the organic light emitting diode OLED.

When the fifth and sixth transistors T5 and T6 are turned on, the driving current Ids of the display pixel driver 110 is supplied to the organic light emitting diode OLED. As a result, the organic light emitting diode OLED of the first display pixel DP1 emits light.

The seventh transistor T7 is connected to the anode electrode of the organic light emitting diode OLED and the second power voltage line VINL2. The seventh transistor T7 is turned on by the k−1^{th} scan line Sk−1 and connects the anode electrode of the organic light emitting diode OLED and the second power voltage line VINL2. As a result, the anode electrode of the organic light emitting diode OLED is discharged to the second power voltage. The control electrode of the seventh transistor T7 is connected to the k−1^{th} scan line Sk−1 the first electrode is connected to the anode electrode of the organic light emitting diode OLED, and the second electrode is connected to the second power voltage line VINL2.

The organic light emitting diode OLED emits light according to the driving current Ids of the display pixel driver 110. The amount of light emitted by the organic light emitting diode OLED may be proportional to the driving current Ids. The anode electrode of the organic light emitting diode OLED is connected to the first electrode of the second transistor T2 and the second electrode of the seventh transistor T7. The cathode electrode is connected to the fourth power voltage line VSSL. The fourth power voltage is supplied to the fourth power voltage line VSSL.

The storage capacitor Cst is connected to the control electrode of the first transistor T1 and third power voltage line VDDL, and maintains the voltage of the control electrode of the first transistor T1. The storage capacitor Cst has one electrode connected to the control electrode of the first transistor T1 and another electrode connected to the third power voltage line VDDL. The first to seventh transistors T1 to T7 may be PMOS transistors as illustrated in FIG. 12. In another embodiment, the first to seventh transistors T1 to T7 may be NMOS transistors.

The auxiliary pixel RP1 includes an auxiliary pixel driver 210. The auxiliary pixel RP1 does not include an organic light emitting diode OLED. The auxiliary pixel driver 210 is connected to the auxiliary line RL. The driving current of the auxiliary pixel driver 210 is supplied to the organic light emitting diode OLED of the j^{th} display pixel DPj through the auxiliary line RL.

The auxiliary pixel driver 210 may be connected to a plurality of scan lines, an auxiliary data line, a plurality of emission control lines, and a plurality of power lines. The auxiliary pixel driver 210 may be connected to the k−1^{th} and k scan lines Sk−1 and Sk, first auxiliary data line RD1, k^{th} emission control lines Ek, and first to third power voltage lines VINL1, VINL2, and VDDL.

The auxiliary pixel driver 210 may include a plurality of transistors, e.g., first to seventh transistors T1′, T2′, T3′, T4′, T5′, T6′, and T7′. The first, third, fourth, and fifth transistors T1′, T3′, T4′ and T5′ of the auxiliary pixel driver 210 and a storage capacitor Cst′ may be configured to be substantially the same as the first, third, fourth, and fifth transistors and the storage capacitor Cst.

The second transistor T2′ is connected to the first electrode of the first transistor T1′ and the first auxiliary data line RD1. The second transistor T2′ is turned on by an scan signal of the k^{th} scan line Sk, and connects the first electrode of the first transistor T1′ and the first auxiliary data line RD1. An auxiliary data voltage of the first auxiliary data line RD1 is supplied to the first electrode of the first transistor T1′. A control electrode of the second transistor T2′ is connected to the k^{th} scan line Sk, the first electrode is connected to the first auxiliary data line RD1, and the second electrode is connected to the first electrode of the first transistor T1′.

The sixth transistor T6′ is connected to a second electrode of the first transistor T1′ and an auxiliary line RL. The sixth transistor T6′ is turned on by a emission control signal of a k^{th} emission control line Ek to connect the second electrode of the first transistor T1′ and the auxiliary line RL. A control electrode of the sixth transistor T6′ is connected to the k^{th} emission control line Ek, the first electrode is connected to the second electrode of the first transistor T1′, and the second electrode is connected to the auxiliary line RL. When the fourth′ and fifth′ transistors T4′ and T5′ are turned on, a driving current is supplied to an organic light emitting diode OLED of the j^{th} display pixel DPj. Thus, the organic light emitting diode OLED of the j^{th} display pixel DPj emits light.

The seventh transistor T7′ is connected to the auxiliary line RL and the first power voltage line VINL1. The seventh transistor T7′ is turned on by an scan signal of a k−1 th scan line Sk−1 to connect the auxiliary line RL and the first power voltage line VINL1. As a result, the auxiliary line RL is discharged to the first power voltage. A control electrode of the seventh transistor T7′ is connected to the k−1th scan line Sk−1, the first electrode is connected to the auxiliary line RL, and the second electrode is connected to the first power voltage line VINL1. The first to seventh transistors T1′ to T7′ may be PMOS transistors or NMOS transistors.

As mentioned above, the display pixel driver 110 of the display pixels DPIs, excluding the jth display pixels DPjs corresponding to the repaired pixel, is connected to the organic light emitting diode to supply a driving current to the organic light emitting diode. However, the display pixel driver 110 of the jth display pixel DPj is not connected to the organic light emitting diode OLED. That is, the display pixel driver 110 of the jth display pixel DPj cannot play its role due to it being defective, and thus disconnects the display pixel driver 110 and the organic light emitting diode OLED from each other through a laser process and connects the anode electrode of the organic light emitting diode OLED of the jth display pixel DPj to the auxiliary line RL. As a result, the anode electrode of the organic light emitting diode OLED of the jth display pixel DPj may be connected to the auxiliary pixel driver 210 of the first auxiliary pixel RP1 through the auxiliary line RL. Therefore, the organic light emitting diode OLED of the jth display pixel DPj receives a driving current from the auxiliary pixel driver 210 of the first auxiliary pixel RP1 and emits light. The jth display pixel DPj may therefore be repaired.

Because the auxiliary line RL and the anode electrodes of the organic light emitting diodes OLED of the display pixels are superposed, parasitic capacitances PC may be formed between the auxiliary line RL and the organic light emitting diodes OLED of the display pixels as illustrated in FIG. 12. Furthermore, the auxiliary line RL is formed adjacent and parallel to the kth scan line Sk, and thus a fringe capacitance FC may be formed between the auxiliary line RL and the kth scan line Sk. Since a potential of the auxiliary line RL may be changed by the coupling voltage generated by the parasitic capacitances PC and fringe capacitances FCs, a problem may occur in that the organic light emitting diode OLED of the jth display pixel DPj corresponding to the repaired pixel may erroneously emit light.

In order to resolve this, one or more embodiments compute a coupling voltage CPV generated by the parasitic capacitances between the display pixels DPs connected to the same scan line as the repaired pixel RDP1 and RDP2, and compute a compensation current CMI using the generated coupling voltage CPV. Such a compensation current CMI is aggregated with an auxiliary current RI corresponding to the auxiliary data RD, and a compensation gray value CMG is calculated according to the aggregated current. According to the compensation gray value CMG, an auxiliary data voltage is supplied through the first auxiliary data line RD1. Thus, in these embodiments, the voltage of the auxiliary line RL is changed due to the parasitic capacitances PC and fringe capacitances FC, to thereby prevent the organic light emitting diode OLED from erroneously emitting light.

FIG. 13 is graph illustrating an example of a relationship between a gray value of a repaired pixel and offset when display pixels display a single color. In FIG. 13, the x axis represents a gray value GV of the repaired pixel and the y axis represents an offset. An offset may correspond to a value to be added to a gray value of the auxiliary data RD, taking into account the coupling voltage when delivering current to the repaired pixel through the auxiliary line RL.

The coupling voltage provided to the auxiliary line RL when the display pixels DPs display black (BLK) may be near 0. When the coupling voltage is low, a relatively high current must be added to the auxiliary line RL. In such a case, the offset will be relatively high and the current amount being provided to the auxiliary line RL will be relatively high. As the gray value increases, the offset decreases.

The coupling voltage to be provided to the auxiliary line RL when the display pixels DPs display green GR will become higher. In such a case, the offset will be relatively low and the current amount provided to the auxiliary line RL will be relatively low. As the gray value increases, the offset will decrease.

The coupling voltage provided to the auxiliary line RL when the display pixels DPs display blue (BR) will become higher (see FIG. 8). In such a case, the offset will become relatively lower and thus the current amount provided to the auxiliary line RL will become lower. As the gray value increases, the offset will decrease.

The offset is shifted up/down only slightly according to a color displayed on the display pixels DPs. For enhancement of speed, a basic offset may be derived according to the gray value of the repaired pixel, and a compensation offset may be derived according to a compensation current CMI (see FIG. 2), thereby deriving a compensation gray value CMG (see FIG. 2).

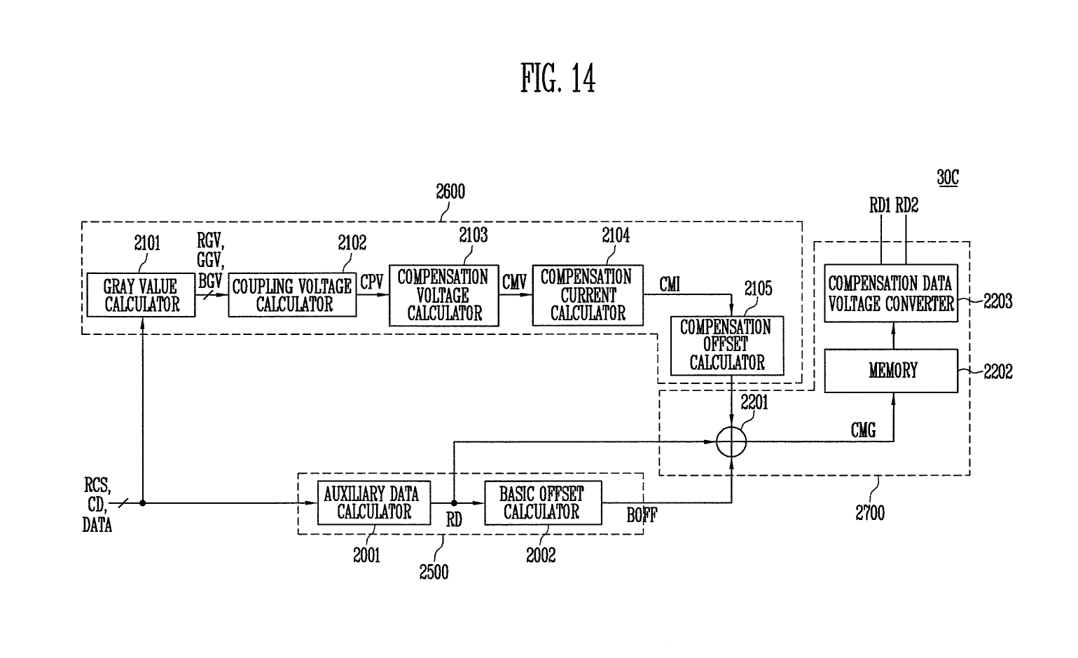

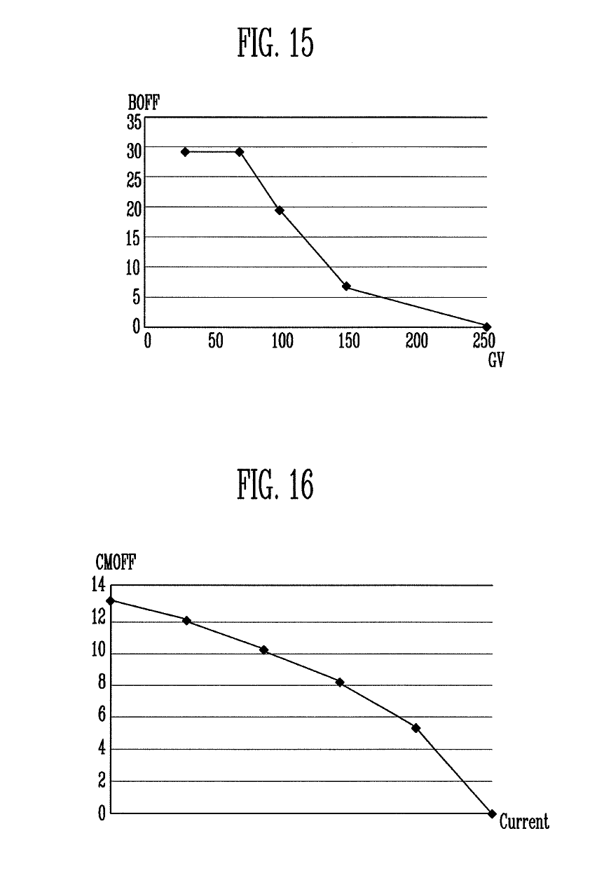

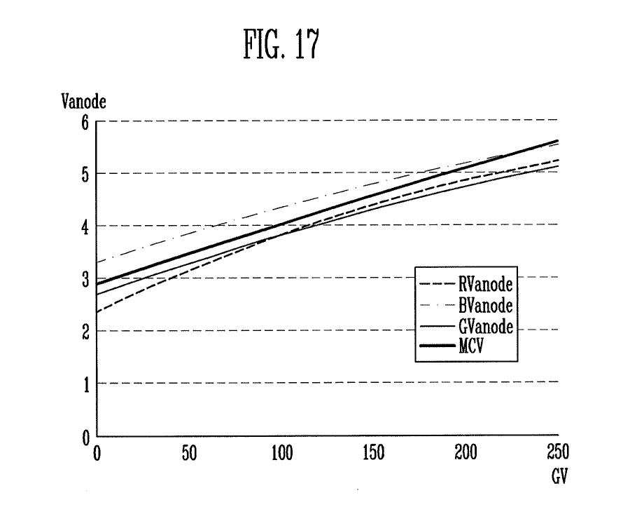

FIG. 14 illustrates a modified embodiment of a data driver. FIG. 15 is a graph illustrating an example of a relationship between a gray value of auxiliary data and a basic offset. FIG. 16 illustrates an example of a relationship between a compensation current and a compensation offset.

Referring to FIG. 14, the data driver 30C includes a basic offset computing block 2500, compensation offset computing block 2600, and compensation data driving block 2700. The basic offset computing block 2500 includes an auxiliary data calculator 2001 and a basic offset calculator 2002. The auxiliary data calculator 2001 may correspond to the auxiliary data calculator 1001 explained with reference to FIGS. 2 and 4.

The basic offset calculator 2002 receives auxiliary data RD and generates a basic offset BOFF according to the auxiliary data RD. Referring to FIG. 15, the x axis represents a gray value GV corresponding to the auxiliary data RD and the y axis represents a basic offset BOFF. The basic offset calculator 2002 converts the auxiliary data RD received according to the graph illustrated in FIG. 15 into the basic offset BOFF. For example, the graph of FIG. 15 may be determined with reference to the graphs of FIG. 13. For example, the graph of FIG. 15 may be determined with reference to the graphs of FIG. 13. For example, when the gray value GV is about or less than 70, and basic offset BOFF may be set to a predetermined value. When the gray value GV is about or more than 70, the basic offset BOFF may be defined as a graph GR from which a certain value has been deducted when the display pixels DPs display green.

The compensation offset computing block 2500 includes a gray value calculator 2101, coupling voltage calculator 2102, compensation voltage calculator 2103, compensation current calculator 2104 and compensation offset calculator 2105.

The gray value calculator 2101, coupling voltage calculator 2102, compensation voltage calculator 2013, and compensation current calculator 2104 may be the same as the gray value calculator 1101, coupling voltage calculator 1102, compensation voltage calculator 1103, and compensation current calculator 1104 explained with reference to FIGS. 2 to 6. Hereinafter, repeated explanation is omitted.

The compensation offset calculator 2105 receives a compensation current CMI from the compensation current calculator 2104. The compensation offset calculator 2105 generates a compensation offset CMOFF according to the compensation current CMI. Referring to FIG. 16, the x axis represents the compensation current CMI and the y axis represents the compensation offset CMOFF. As the compensation current CMI increases, the compensation offset CMOFF decreases. The compensation offset calculator 2105 converts the compensation current CMI received according to the graph illustrated in FIG. 16 into the compensation offset CMOFF.

The compensation data driving block 2700 includes an calculator 2201, memory 2202, and compensation data voltage converter 2203. The calculator 2201 aggregates the auxiliary data RD, basic offset BOFF, and compensation offset CMOFT, and outputs a compensation gray value CMG. The compensation gray value CMG is stored in the memory 2202. Then, the compensation data voltage converter 1108 receives the compensation gray value CMG stored in the memory 1107, and converts the compensation gray value CMG into a compensation data voltage. The converted compensation data voltage is supplied to a corresponding auxiliary line RL.

FIG. 17 is a graph illustrating examples of coupling voltages approximately normalized according to a coupling voltage according to a red gray value, a coupling voltage according to a green gray value, and a coupling voltage according to a blue gray value. Referring to FIG. 17, each of the coupling voltage according to the red gray value, coupling voltage according to the green gray value, and coupling voltage according to the blue gray value increases as the corresponding gray value increases. Taking these coupling voltages into consideration, an approximately normalized coupling voltage graph MCV may be defined.

For example, the normalized coupling voltage graph MCV may be linearized for simple calculation. Furthermore, despite a slight error, the normalized coupling voltage graph MCV may be applied commonly to each of the pixels connected to the same scan line as the repaired pixel RDP1 and RDP2 (see FIG. 2), regardless of color. Regardless of the colors of pixels, the normalized coupling voltage graph MCV may be used to compute a coupling voltage related to each pixel. For example, by applying the gray value of each pixel to the normalized coupling voltage graph MCV, a corresponding coupling voltage may be computed.

The coupling voltage calculator 1102, 2102 may compute the coupling voltage CPV by the pixels connected to the same scan line as the repaired pixel RDP1 and RDP2 according to Equation 12, instead of Equation 7.

CPV=ΣGrayV (12)

In Equation 12, CPV represents the coupling voltage by the pixels connected to the same scan line as the repaired pixel RDP1 and RDP2. GrayV represents a coupling voltage of each pixel computed by applying a gray value of each pixel to the normalized coupling voltage graph MCV. By aggregating the coupling voltage GrayV of each pixel, the coupling voltage CPV by the pixels connected to the same scan line as the repaired pixel RDP1 and RDP2 may be computed.

The coupling voltage calculator 1102, 2102 will apply the gray value of each pixel to the normalized coupling voltage graph MCV to compute the coupling voltage GrayV of each pixel, and aggregate the coupling voltage GrayV of each pixel, thereby computing the coupling voltage CPV by the pixels connected to the same scan line as the repaired pixel RDP1 and RDP2. For example, the coupling voltage calculator 1102, 2102 may provide a look-up table according to the normalized coupling voltage graph MCV and may compute the coupling voltage GrayV of each pixel according to the gray value of each pixel.

In this embodiment, the coupling voltage between the auxiliary line and display pixels is computed according to the gray values corresponding to the display pixels connected to the same scan line as the repaired pixel. According to the coupling voltage, the compensation data voltage to be applied to the auxiliary line is determined. That is, the voltage applied to the auxiliary line is compensated adaptively to the gray value corresponding to the display pixels. The potential of the auxiliary line will not be changed intentionally. Therefore, an organic light emitting display device with improved reliability will be provided.

The data drivers of the aforementioned embodiments may be incorporated within an integrated circuit chip with outputs coupled to an interface. The interface may be the outputs of the chip or the corresponding signal lines themselves.

The calculators, drivers, controllers, and processors of the embodiments described herein may be implemented in logic which, for example, may include hardware, software, or both. When implemented at least partially in hardware, the calculators, drivers, controllers, and/or processors may be, for example, any one of a variety of integrated circuits including but not limited to an application-specific integrated circuit, a field-programmable gate array, a combination of logic gates, a system-on-chip, a microprocessor, or another type of processing or control circuit.

When implemented in at least partially in software, the calculators, drivers, controllers, and processors may include, for example, a memory or other storage device for storing code or instructions to be executed, for example, by a computer, processor, microprocessor, controller, or other signal processing device. The computer, processor, microprocessor, controller, or other signal processing device may be those described herein or one in addition to the elements described herein. Because the algorithms that form the basis of the methods (or operations of the computer, processor, microprocessor, controller, or other signal processing device) are described in detail, the code or instructions for implementing the operations of the method embodiments may transform the computer, processor, controller, or other signal processing device into a special-purpose processor for performing the methods described herein.

By way of summation and review, defects may occur in pixels during a process of manufacturing an organic light emitting display device. This may deteriorate the yield rate of the organic light emitting display device. In an attempt to improve this, a method has been proposed for forming auxiliary pixels in the organic light emitting display device and connecting a defective pixel with one of the auxiliary pixels, thereby repairing the defective pixel. For example, transistors of the defective pixel and organic light emitting diode are electrically disconnected from each other, while electrically connecting the transistors of the auxiliary pixel and the organic light emitting diode of the defective pixel. For example, the organic light emitting diode of the defective pixel may emit light by driving transistors of the auxiliary pixel.

Parasitic capacitances may be formed between an auxiliary line and a plurality of organic light emitting diodes, and a fringe capacitance may be formed between the auxiliary line and an scan line adjacent to the auxiliary line. These parasitic capacitances and fringe capacitance causes change of voltage of the auxiliary line, and causes the organic light emitting diode inside the repaired pixel to emit light.

In accordance with one or more of the aforementioned embodiments, as the potential of the auxiliary line is effectively controlling, the organic light emitting diode of the repaired pixel is prevented from erroneously emitting light.

Example embodiments have been disclosed herein, and although specific terms are employed, they are used and are to be interpreted in a generic and descriptive sense only and not for purpose of limitation. In some instances, as would be apparent to one of skill in the art as of the filing of the present application, features, characteristics, and/or elements described in connection with a particular embodiment may be used singly or in combination with features, characteristics, and/or elements described in connection with other embodiments unless otherwise indicated. Accordingly, it will be understood by those of skill in the art that various changes in form and details may be made without departing from the spirit and scope of the present invention as set forth in the following claims.

What is claimed is:

1. An organic light emitting display device, comprising:
a display area including display pixels connected to data lines;
a non-display area including an auxiliary pixel connected to an auxiliary data line;
an auxiliary line extending in a direction intersecting the data lines and the auxiliary data line, the auxiliary line to connect a repaired pixel and the auxiliary pixel; and
a data driver to supply data voltages to the data lines according to gray values corresponding to the display pixels, and to supply a compensation data voltage to the auxiliary data line according to a gray value of the repaired pixel, wherein the data driver is to compute a coupling voltage between the auxiliary line and the display pixels according to the gray values corresponding to the display pixels and is to determine the compensation data voltage according to the coupling voltage.

2. The organic light emitting display device as claimed in claim 1, wherein the data driver includes:
a compensation voltage computer to compute a difference between a predetermined maximum coupling voltage and the coupling voltage as a compensation voltage; and
a compensation current computer to compute a compensation current based on the compensation voltage.

3. The organic light emitting display device as claimed in claim 2, wherein the data driver includes an auxiliary current computer to convert the gray value of the repaired pixel into an auxiliary current.

4. The organic light emitting display device as claimed in claim 3, wherein the data driver includes:
a compensation gray value computer to aggregate the compensation current and the auxiliary current and to convert the aggregated current to a compensation gray value, the compensation data voltage to be determined according to the compensation gray value.

5. The organic light emitting display device as claimed in claim 2, wherein the data driver includes:
a compensation offset computer to generate a compensation offset based on the compensation current; and
a basic offset computer to generate a basic offset according to the gray value of the repaired pixel, the compensation data voltage to be determined according to the compensation offset and the basic offset.

6. The organic light emitting display device as claimed in claim 5, wherein the data driver includes a computer to aggregate the compensation offset, basic offset, and gray value of the repaired pixel and to output a compensation gray value, the compensation data voltage to be determined according to the compensation gray value.

7. The organic light emitting display device as claimed in claim 1, wherein the data driver includes a gray value computer to compute red gray values supplied to red pixels, green gray values supplied to green pixels, and blue gray values supplied to blue pixels.

8. The organic light emitting display device as claimed in claim 7, wherein the data driver includes a coupling voltage computer to calculate red coupling voltages between the red pixels and the auxiliary line according to the red gray values, green coupling voltages between the green pixels and the auxiliary line according to the green gray values, and blue coupling voltages between the blue pixels and the auxiliary line according to the blue gray values, the coupling voltage computer to aggregate the red coupling voltages, green coupling voltages, and blue coupling voltages to generate the coupling voltage.

9. The organic light emitting display device as claimed in claim 8, wherein the coupling voltage computer is to compute a first anode voltages for organic light emitting diodes in the red pixels according to the red gray values, second anode voltages for organic light emitting diodes in the green pixels according to the green gray values, and third anode voltages for organic light emitting diodes in the blue pixels according to the blue gray values.

10. The organic light emitting display device as claimed in claim 9, wherein the coupling voltage computer is to calculate the red coupling voltages according to the first anode voltages for the organic light emitting diodes in the red pixels, the green coupling voltages according to the second anode voltages for the organic light emitting diodes in the green pixels, and the blue coupling voltages according to the third anode voltages for the organic light emitting diodes in the blue pixels.

11. The organic light emitting display device as claimed in claim 8, wherein:
the coupling voltage computer includes:
a first look-up table representing a relationship between the red gray values and the red coupling voltages,
a second look-up table representing a relationship between the green gray values and the green coupling voltages, and
a third look-up table representing a relationship between the blue gray values and the blue coupling voltages, and
the coupling voltage computer is to calculate the red coupling voltages based on the first look-up table, the green coupling voltages based on the second look-up table, and the blue coupling voltages based on the third look-up table.

12. The organic light emitting display device as claimed in claim 8, wherein:
the coupling voltage computer includes a look-up table representing a relationship between a gray value and a normalized coupling voltage, and
the coupling voltage computer is to calculate the red coupling voltages, green coupling voltages, and blue coupling voltages using in common the look-up table.

13. The organic light emitting display device as claimed in claim 1, wherein the display pixels are connected to a same scan line.

14. The organic light emitting display device as claimed in claim 1, further comprising:
an scan line and emission control line intersecting the data lines and the auxiliary data line; and
an scan driver to supply an scan signal to the scan line and an emission control signal to the emission control line.

15. The organic light emitting display device as claimed in claim 14, wherein the display pixels and the auxiliary pixel are connected to the scan line and the emission control line.

16. The organic light emitting display device according as claimed in claim 1, wherein the data driver is to synchronize the data voltages and the compensation data voltage to each other, and is to supply the synchronized data voltages and the compensation data voltage to the data lines and the auxiliary data lines.

17. A data driver circuit, comprising:
an interface; and
a data driver coupled to the interface,
wherein the data driver is to supply data voltages to data lines based on gray values corresponding to display pixels, and is to supply a compensation data voltage to an auxiliary data line based on a gray value of a repaired pixel, and wherein the data driver is to compute a coupling voltage between the auxiliary line and the display pixels according to the gray values corresponding to the display pixels and is to determine the compensation data voltage according to the coupling voltage.

18. The data driver circuit as claimed in claim 17, wherein the data driver includes:
a compensation voltage computer to compute a difference between a predetermined maximum coupling voltage and the coupling voltage as a compensation voltage; and
a compensation current computer to compute a compensation current based on the compensation voltage.

19. The data driver circuit as claimed in claim 18, wherein the data driver includes an auxiliary current computer to convert the gray value of the repaired pixel into an auxiliary current.

20. The data driver circuit as claimed in claim 19, wherein the data driver includes a compensation gray value computer to aggregate the compensation current and the auxiliary current and to convert the aggregated current to a compensation gray value, the compensation data voltage to be determined according to the compensation gray value.
